(19) United States
(12) Patent Application Publication
(10) Pub. No.: US 2018/0255387 A1
(43) Pub. Date: Sep. 6, 2018

(54) EARPLUG

(71) Applicant: UNIQUE SAFETY EQUIPMENT CO., LTD., NEW TAIPEI CITY (TW)

(72) Inventor: LIN-GO CHEN, NEW TAIPEI CITY (TW)

(21) Appl. No.: 15/448,594

(22) Filed: Mar. 3, 2017

(51) Int. Cl. H04R 1/10

(52) U.S. Cl. CPC H04R 1/105; H04R 1/1016; H04R 1/1066

(57) ABSTRACT

An earplug installed to an in-ear headphone includes a fixing portion with an end provided to be plugged into a user's ear, a first hole formed on a surface of the fixing portion, a groove formed and extended inwardly from the other end of the fixing portion and communicated to the first hole, and a tube formed at a position of the groove corresponsive to the first hole; and a closed portion disposed at an end of the fixing portion having the groove and coupled to the tube, and a second hole being formed at a joint between the closed portion and the tube and communicated to the tube, and the closed portion seals the groove, and the groove is filled up with air, so that the groove defines an annular elastic restoring space.

### FIELD OF THE INVENTION

The present invention relates to the field of earplugs, particularly to an earplug with the features of good compressibility and high structural stability.

### BACKGROUND OF THE INVENTION

### 1. Description of the Related Art

At present, headphone is a necessary device for listening to music, and the headphone is generally divided into an over-the-ear headphone, an in-ear headphone and an earplug headphone, and different types of headphones have different way of fixing the headphone to a user's ear. For example, the in-ear headphone includes an earphone with an earplug installed to the headphone, so that the headphone can be fixed to a user's ear canal through the earplug with a through hole, and the headphone has the effects of transmitting sound and isolating external sound.

With reference to FIG. 1 for a schematic view of a conventional earplug, the conventional earplug 1 comprises a hollow tube 11 and an outer cover 12, and the hollow tube 11 includes a sound input end and a sound output end, and the outer cover 12 is an elastic member extended backwardly from the top of the sound output end of the hollow tube 11. However, such earplug 1 must be manufactured with different sizes to fit the diameter of the ear canal of different users in practical use. In other words, the size of the outer cover 12 must be adjusted in the manufacturing process of the earplug 1 before the earplug 1 is able to fit the diameter of the ear canal of different users. Such manufacture incurs a higher manufacturing cost, and users have to try different sized earplugs 1 before they know which one fits them. Obviously, the conventional earplug 1 is very inconvenient. In addition, most conventional earplugs 1 are integrally formed and made of a soft material, so that after the earplugs have been used for a long time or a specific number of times, the earplug 1 will be deformed. Particularly, the outer cover 12 without any specific fixed structure will reduce its original effect of isolating external sound.

In view of the aforementioned drawbacks of the conventional earplug 1, the inventor of the present invention based on years or experience in the related industry to conduct extensive research and experiment, and finally developed an earplug in accordance with the present invention to overcome the drawback of the prior art.

### 2. Summary of the Invention

Therefore, it is a primary objective of the present invention to overcome the drawbacks of the prior art by providing an earplug capable of fitting the diameter and shape of the ear canal of different users and providing sufficient structural stability to prevent deformation effectively.

To achieve the aforementioned and other objectives, the present invention provides an earplug comprising: a fixing portion, with an end provided to be plugged into a user's ear, and having a first hole formed on a surface of the fixing portion, a groove formed and inwardly extended from the other end of the fixing portion and communicated to the first hole, and a tube disposed at a position of the groove corresponsive to the first hole and integrally formed with the fixing portion, and extended from an end for plugging the fixing portion into the user's ear to the other end, and the tube being provided for connecting a broadcasting portion of the headphone to transmit sound into the user's ear through the tube; and a closed portion, disposed at an end of the fixing portion having the groove, and coupled to the tube, and a second hole being formed at a joint of the closed portion and the tube and communicated to the tube, and the closed portion sealing the groove, and the interior of the groove being filled up with air, so that the groove defines an annular elastic restoring space.

Wherein, the fixing portion is made of a soft material, and the closed portion is made of a hard material, so as to enhance the structural stability of the closed portion and connect the headphone more securely.

In the present invention, an elastically restoring space is formed by the interior of the groove and the relative position of the tube, so that after the earplug enters into the user's ear canal, the compressed earplug is capable of coping with the air existed in the groove after the closed portion is sealed, and restoring its original shape quickly, so that the earplug is fixed into the user's ear canal. In addition, the elastically restoring space provides sufficient structural stability to the fixing portion to prevent the fixing portion from being deformed easily. As a result, the earplug has the advantages of fitting the diameter and shape of the ear canal of different s and providing a high structural stability.

### BRIEF DESCRIPTION OF THE DRAWINGS

FIG. 1 is a schematic view of a conventional earplug;

FIG. 2 is a cross-sectional view of an earplug of a preferred embodiment of the present invention;

FIG. 3 is a schematic view of installing an earplug of a preferred embodiment of the present invention; and

FIG. 4 is a schematic view of plugging an earplug of a preferred embodiment of the present invention into a user's ear canal.

### DESCRIPTION OF THE PREFERRED EMBODIMENTS

The above and other objects, features and advantages of this disclosure will become apparent from the following detailed description taken with the accompanying drawings.

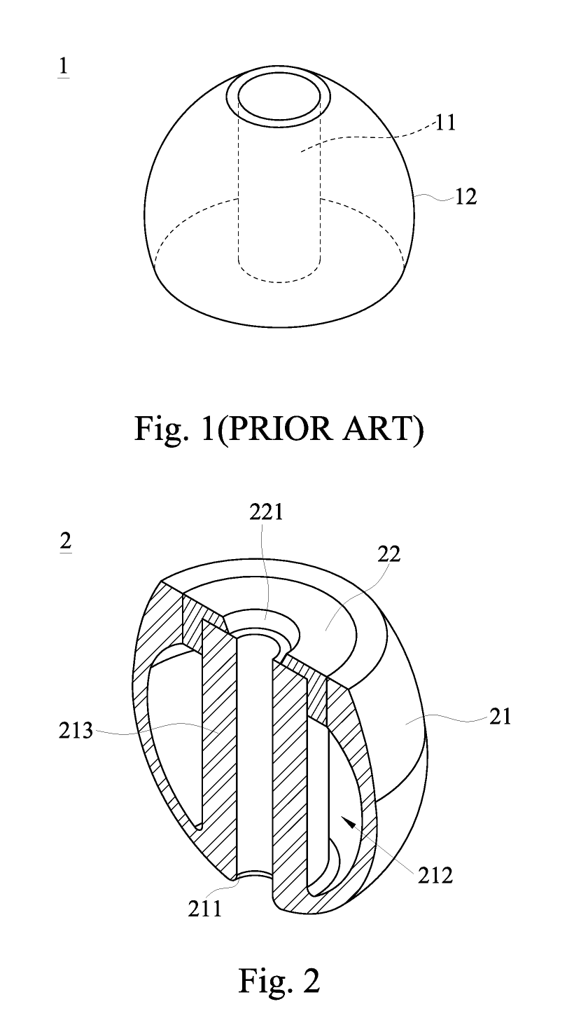

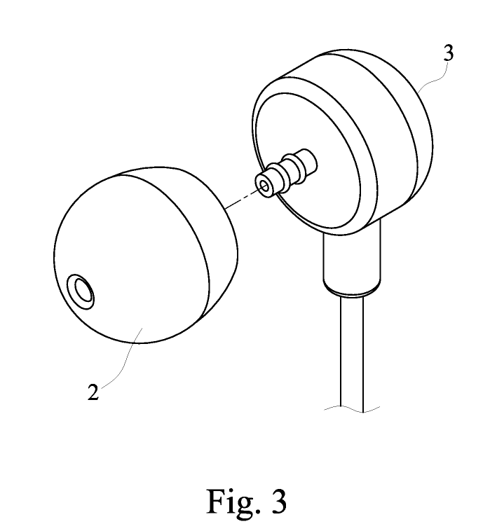

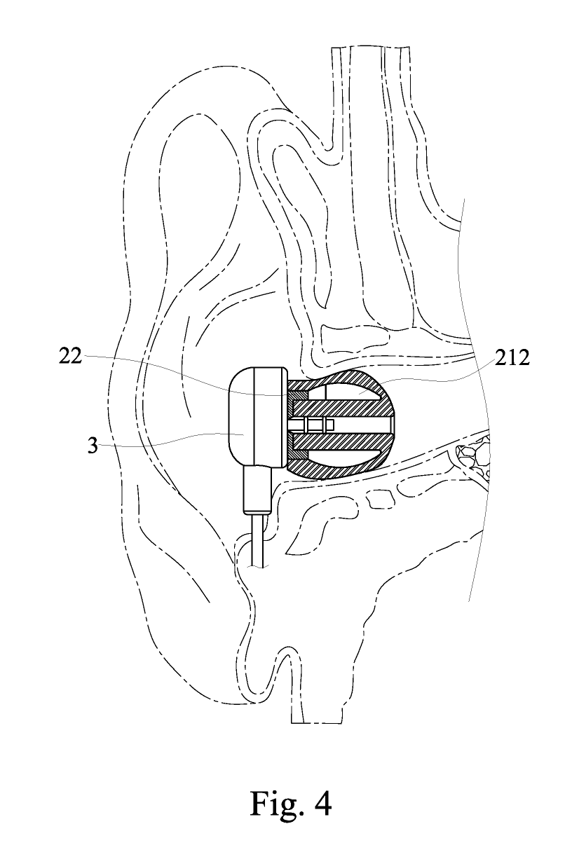

With reference to FIGS. 2 to 4 for a cross-sectional view of an ear plug, a schematic view of installing the ear plug, and a schematic view of plugging the earplug into a user's ear canal in accordance with a preferred embodiment of the present invention respectively, the earplug 2 is installed to an in-ear headphone 3 and the earplug 2 comprises a fixing portion 21 and a closed portion 22. An end of the fixing portion 21 is provided to be plugged into a user's ear, and a first hole 211 is formed on a surface of the fixing portion 21, and a groove 212 is formed and extended inwardly from the other end of the fixing portion 21, and the groove 212 is communicated to the first hole 211, and a tube 213 is disposed at a position of the groove 212 corresponsive to the first hole 211 and integrally formed with the fixing portion 21, and the tube 213 is extended from an end for plugging the fixing portion 21 into the user's ear to the other end, and the tube 213 is coupled to a broadcasting portion of the headphone for transmitting the sound into the user's ear through the tube 213. The closed portion 22 is disposed at an end of the fixing portion 21 having the groove 212 and coupled to the tube 213, and a second hole 221 is formed at a joint of the closed portion 22 and the tube 213 and communicated to the tube 213, and the closed portion 22 seals the groove 212, and the groove 212 is filled up with air, so that the groove 212 defines an annular elastic restoring space.

With the elastically restoring space formed by sealing the groove 212 by the closed portion 22, the earplug 2 can be pressed to enter into the user's ear canal, and the fixing portion 21 can restore its original shape quickly due to the air pressure of the elastically restoring space filled up with air, so that the headphone 3 can be fixed into the user's ear canal. In other words, the elastically restoring space has an effect similar to an airbag. Regardless of the shape and diameter of the user's ear canal, the earplug of the invention fits different ear canals by the expansion force of the air pressure in the elastically restoring space as shown in FIG, 4. In this preferred embodiment, the fixing portion 21 is made of a soft material, and the closed portion 22 is made of a hard material, so that the closed portion 22 made of a hard material can enhance the rigidity between the earplug 2 and the headphone 3 and prevent deformation occurred at the joint between the earplug 2 and the headphone 3 after a long time of use.

Since the sealed groove 212 is filled up with air, therefore the structural rigidity of the fixing portion 21 can be improved. The air in the groove 212 will not be decreased, so that the fixing portion 21 always can restore its original shape regardless of the number of times of pressing, so as to prevent the soft fixing portion 21 from being deformed easily after a number of times of pressing, and the fixing portion 21 has a good structural rigidity.

In summation of the description above, the present invention seals the groove 212 by the closed portion 22 and keeps the air in the groove 212 to define the elastically restoring space, so that the earplug 2 can be pressed into the user's ear successfully. Regardless of the diameter and shape of the user's ear canal, the fixing portion 21 can be fixed into the ear canal securely by using the elastically restoring space, and it is not necessary to change the earplug 2 to fit different sizes. With the configuration of the closed portion 22, the joint between the earplug 2 and the headphone 3 has sufficient structural rigidity to prevent deformation occurred at the joint between the earplug 2 and the headphone 3 after a long time of use, and avoid discomfort of wearing.

What is claimed is:

1. An earplug, installed to an in-ear headphone, comprising:
a fixing portion, with an end provided to be plugged into a user's ear, and having a first hole, formed on a surface of the fixing portion;
a groove, formed and inwardly extended from an another end of the fixing portion and communicated to the first hole;
a tube, disposed at a position of the groove corresponsive to the first hole and integrally formed with the fixing portion, the tube extending from an end of the fixing portion being plugged into the user's ear to an another end, and the tube being provided for connecting with a broadcasting portion of the headphone to transmit sound into the user's ear through the tube; and
a closed portion, disposed at an end of the fixing portion having the groove, and coupled to the tube, and a second hole being formed at a joint of the closed portion and the tube and communicated to the tube, and the closed portion sealing the groove, and the groove being filled up with air, so that the groove defines an annular elastic restoring space.

2. The earplug of claim 1, wherein the fixing portion is made of a soft material and the closed portion is made of a hard material.
